(19) United States
(12) Patent Application Publication
(10) Pub. No.: US 2016/0215867 A1
(43) Pub. Date: Jul. 28, 2016

(54) IMBALANCED SPLINE FOR A DRIVESHAFT

(71) Applicant: CATERPILLAR INC., Peoria, IL (US)

(72) Inventors: Thomas Franklin Hylton, II, Delphi, IN (US); Gregory David Schroeder, West Lafayette, IN (US)

(73) Assignee: CATERPILLAR INC., Peoria, IL (US)

(21) Appl. No.: 14/608,025

(22) Filed: Jan. 28, 2015

(51) Int. Cl. F16H 55/14; F16H 55/17

(52) U.S. Cl. CPC F16H 55/14; F16H 55/17

(57) ABSTRACT

A counterbalanced spline for use with a compressor is disclosed. The counterbalanced spline has a substantially cylindrical body having a central axis and a plurality of teeth disposed about the central axis. The counterbalanced spline also has a counterweight disposed about a portion of the central axis of the substantially cylindrical body.

### TECHNICAL FIELD

The present disclosure relates generally to a spline and, more particularly, to an imbalanced spline for a driveshaft.

### BACKGROUND

Internal combustion engines such as diesel engines, gasoline engines, or gaseous fuel-powered engines are operated to generate a power output. In many systems, this power output drives a compressor for a downstream application. For example, the compressor may have a driveshaft rotated by the engine to generate a flow of pressured air.

A compressor can include one or more pistons powered by the driveshaft to compress an intake fluid. In a single-cylinder compressor, a torsional imbalance may exist, for example due to the movement of only one cylinder during operation. In some compressor arrangements, space constraints and the desire to allow the end user operational flexibility give rise to design choices that further exacerbate the inherent imbalance.

One method of addressing imbalances present in single cylinder compressors is described in U.S. Pat. No. 4,509,378 (the '378 patent) issued to Brown on Apr. 9, 1985. The '378 patent describes a reciprocating machine having counterweights and contraweights that are used to balance the inertia forces present in the single cylinder system. For example, two counterweights are attached to a crankshaft of the system and configured to rotate with the crankshaft. The reciprocating machine also includes two contraweights that rotate in the opposite direction from the crankshaft at the same speed as the crankshaft. The counterweights and the contraweights combine forces during operation to balance the primary reciprocating inertia forces associated with the single cylinder.

Although the system of the '378 patent may help to reduce the imbalance present in the reciprocating machine, the location of the counterweights on the rotating shaft may render this solution infeasible or undesirable in applications in which space constraints limit the placement of counterweights. Further, since the counterweights are integral with the rotating shaft in some of the teachings, the flexibility of a user to vary the placement or combination of components is limited. Additionally, due to the integration of the counterweights with the shaft, the user may not be able to tailor the imbalance correction for a user-specific application.

The disclosed system is directed to overcoming one or more of the problems set forth above.

### SUMMARY

In one aspect, the present disclosure is directed to a counterbalanced spline including a substantially cylindrical body having a central axis and a plurality of teeth disposed about the central axis. The counterbalanced spline also includes a counterweight disposed about a portion of the central axis of the substantially cylindrical body.

In another aspect, the present disclosure is directed to a compression system including a fluid compressor having a drive shaft and a male spline configured to mate with an end of the drive shaft. The compression system also includes a counterweight configured to be disposed about a portion of the male spline.

In another aspect, the present disclosure is directed to a power system including an engine having a crankshaft with a female spline. The power system also includes a fluid compressor having a drive shaft and a single piston reciprocatingly connected to the driveshaft. A male spline is configured to mate with the female spline and includes an inner bore configured to removably receive an end of the driveshaft. The power system also includes a counterweight integral with the male spline and configured to be disposed about a portion of the central axis of the male spline defined by an angle. A ratio between a thickness of the counterweight and the angle is approximately 0.16-0.24 millimeters for every 1 degree.

### BRIEF DESCRIPTION OF THE DRAWINGS

FIG. 1 is a cutaway isometric and diagrammatic illustration of an exemplary power system;

FIG. 2 is an exploded perspective view illustration of an exemplary compressor that may be used in the power system of FIG. 1;

FIG. 3 is a perspective view illustration of an exemplary male spline that may be used with the compressor of FIG. 2;

FIG. 4 is a front view illustration of the male spline of FIG. 3; and

FIG. 5 is a cross sectional side view illustration of the male spline of FIGS. 3 and 4.

### DETAILED DESCRIPTION

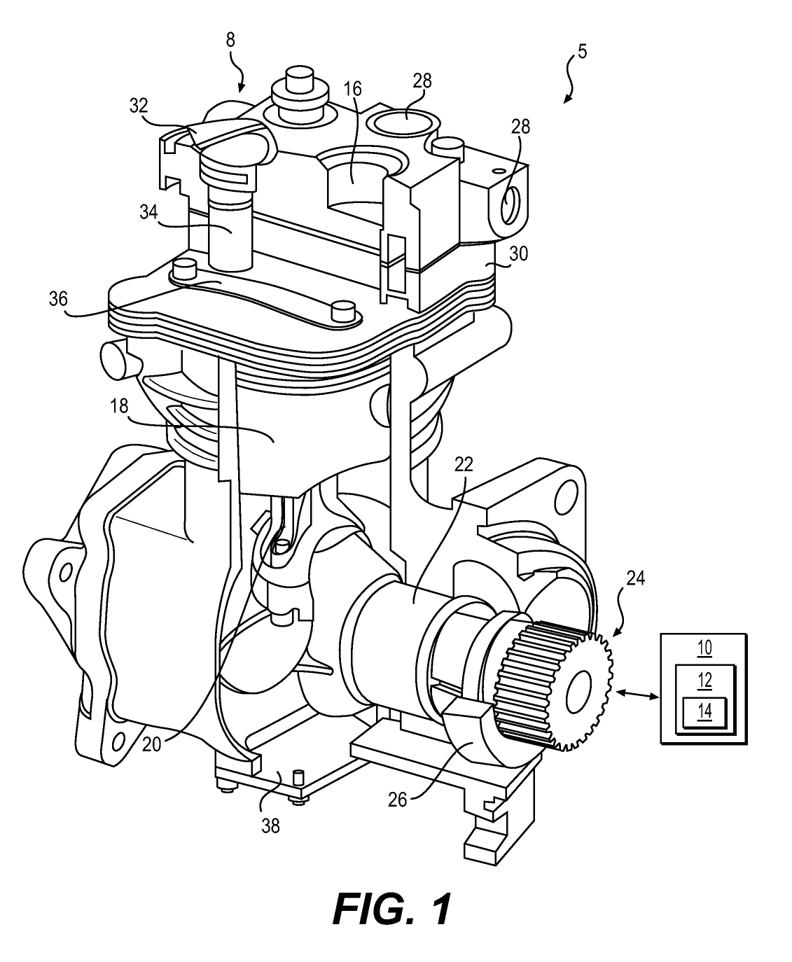

FIG. 1 illustrates a power system 5 having a compressor 8 and a power source 10 that may be operably connected to the compressor 8. The power source 10 may include an engine 12 such as, for example, a diesel engine, a gasoline engine, a gaseous fuel-powered engine (e.g., a natural gas engine), or any other type of combustion engine apparent to one skilled in the art. The power source 10 may also include a crankshaft 14 that may be operably connected to another device, such as compressor 8, to drive the connected device.

In the illustrated embodiment, the compressor 8 is a fluid compressor that includes a fluid intake port 16 for receiving a fluid (e.g., a gas or liquid, such as air) to be compressed by a piston 18. A piston rod 20 connects the piston 18 to a drive shaft 22. The drive shaft 22 may be connected, for example, with the crankshaft 14 of the power source 10 such that a rotation of the crankshaft 14 will result in a corresponding rotation of the drive shaft 22. For example, in the embodiment of FIG. 1, the drive shaft 22 is connected to the crankshaft 14 through a male spline 24 that may interface with the power source 10 via a female spline.

The compressor 8 further includes a counterweight 26 configured to be disposed about the male spline 24 and/or the drive shaft 22 to mitigate imbalances that arise during operation of the compressor 8. For example, in one embodiment, the compressor 8 is a single-cylinder compressor having only one piston 18, and the counterweight 26 offsets the inherent imbalance arising due to the operation of only a single piston 18. For further example, in some embodiments, the drive shaft 22 may have counter-throws that partially offset the inherent imbalance arising due to the single piston 18, and the counterweight 26 may provide the additional offset needed to fully offset the inherent imbalance. That is, in some embodiments, space constraints may limit the counter-throws of the drive shaft 22, and the remaining offset needed to balance the compressor 8 may be provided by the counterweight 26.

Depending on implementation-specific considerations, the male spline 24, the counterweight 26, and the drive shaft 22 may be formed or connected in a variety of suitable ways. For example, in one embodiment, the male spline 24, the counterweight 26, and the drive shaft 22 are formed as separate pieces and coupled together via any suitable connection (e.g., bolts, screws, interference fits, etc.) for operation. In some embodiments, the drive shaft 22 may be configured to removably receive the male spline 24 and the counterweight 26 thereon. Further, in certain embodiments, a bolt may pass through the male spline 24 to removably connect the male spline 24 and the counterweight 26 to the driveshaft 22. As used herein, the term “removably” means that one component may be received by and removed from another component without deformation or destruction of either component.

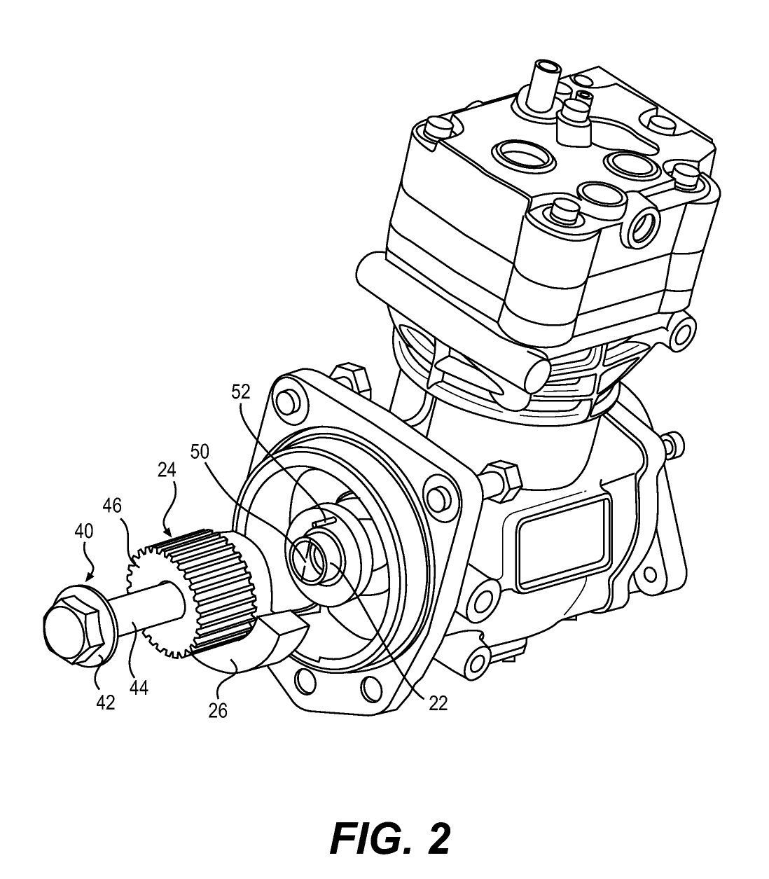

In other embodiments, the male spline 24 and the counterweight 26 are formed as a single-piece assembly (i.e., integrated into one integral piece). In such embodiments, the single-piece assembly (including the male spline 24 and the counterweight 26) may be coupled to the drive shaft 22 in any suitable manner, such as by bolting the single-piece assembly to the drive shaft 22 and/or by forming an interference fit between an outer diameter 50 (shown in FIG. 2) of the drive shaft 22 and an inner diameter 49 (shown in FIG. 5) of the male spline 24.

Still further, in other embodiments, the drive shaft 22, the male spline 24, and the counterweight 26 are formed as a single-piece assembly (i.e., integrated into one integral piece). In such embodiments, the single-piece assembly (including the drive shaft 22, the male spline 24, and the counterweight 26) may be configured to connect to the compressor 8 in any suitable manner for operation, for example, via bolts, screws, interference fits, and so forth. Additionally, in embodiments in which one or more of the drive shaft 22, the male spline 24, and the counterweight 26 are formed as a single-piece assembly, the components may be formed from a single piece of material or one or more techniques may be utilized to integrate the components together to form an integral piece, including but not limited to welding, forming the components in a single mold, binding the components to each other during a heat treatment process, etc.

It should be noted that in some embodiments, the compressor 8 may include one or more additional components not shown or described in FIG. 1 that facilitate the compression of a fluid received through the fluid intake port 16. While the components in any given system will be chosen based on implementation-specific considerations, in some embodiments, the compressor 8 may further include coolant ports 28, a cooling plate 30, an unloader cover 32, an unloader piston 34, one or more discharge reed valves 36, and a crankcase cover 38.

FIG. 2 is an exploded view of the compressor 8 of FIG. 1 further illustrating how one embodiment of the male spline 24 and the counterweight 26 may couple to the drive shaft 22 of the compressor 8. In this embodiment, the male spline 24 and the counterweight 26 are shown as a single-piece assembly, but in other embodiments, these components may be formed in a variety of suitable ways, as discussed above. As shown, the illustrated embodiment includes a fastener 40 having an end portion 42 and an extension 44 extending from the end portion 42 through a body 46 of the male spline 24 to couple the male spline 24 to the drive shaft 22. The fastener 40 may, for example, be a bolt, a screw, or another suitable securement device. Additionally, the male spline 24 and the counterweight 26 are further secured to the drive shaft 22 via an interference fit between the inner diameter 49 (shown in FIG. 5) of the body 46 of the male spline 24 and the outer diameter 50 of the drive shaft 22.

In some embodiments, the male spline 24 and/or the compressor 8 may include one or more alignment mechanisms configured to axially align the male spline 24 with the drive shaft 22 when assembled. For example, the male spline 24 may include a first alignment mechanism 51 (shown in FIGS. 4 and 5) configured to mate with a second alignment mechanism 52 to axially align the male spline 24. By aligning the first alignment mechanism 51 and the second alignment mechanism 52, the male spline 24 may be oriented with respect to the drive shaft 22 for operation.

For example, in the illustrated embodiment, alignment of the first alignment mechanism 51 and the second alignment mechanism 52 results in proper positioning of the counterweight 26 with respect to the piston 18. That is, the counterweight 26 is positioned on a side of the drive shaft 22 opposite from the piston 18 when the first and second alignment mechanisms 51 and 52 are mated. The relative positioning of the counterweight 26 and the piston 18 in the aligned position may enable the counterweight 26 to correct for the inherent imbalance present in the compressor 8 due to operation of only the single piston 18.

In the embodiment of FIG. 2, the first alignment mechanism 51 is an aperture, and the second alignment mechanism 52 is a pin configured to be received by the aperture. However, in other embodiments, the first and second alignment mechanisms 51 and 52, respectively, may take on a variety of suitable forms. For example, the first alignment mechanism 51 may be a male portion (e.g., a pin or other extension) and the second alignment mechanism 52 may be a female portion (e.g., an aperture, passageway, or other receiving feature). For further example, in other embodiments, the alignment mechanisms 51 and 52 may take other suitable forms, such as markings (e.g., timing marks) on each of the male spline 24 and the drive shaft 22 that may be positioned relative to one another to indicate axial alignment.

Further, in some embodiments, the alignment mechanisms 51 and 52 may be configured such that torque is transmitted through the alignment mechanisms 51 and 52 during operation. However, in other implementations, other components, such as the fastener 40 and/or the interference fit formed between the inner diameter 49 of the male spline 24 and the outer diameter 50 of the drive shaft 22, may be configured to handle some or all of the load during operation.

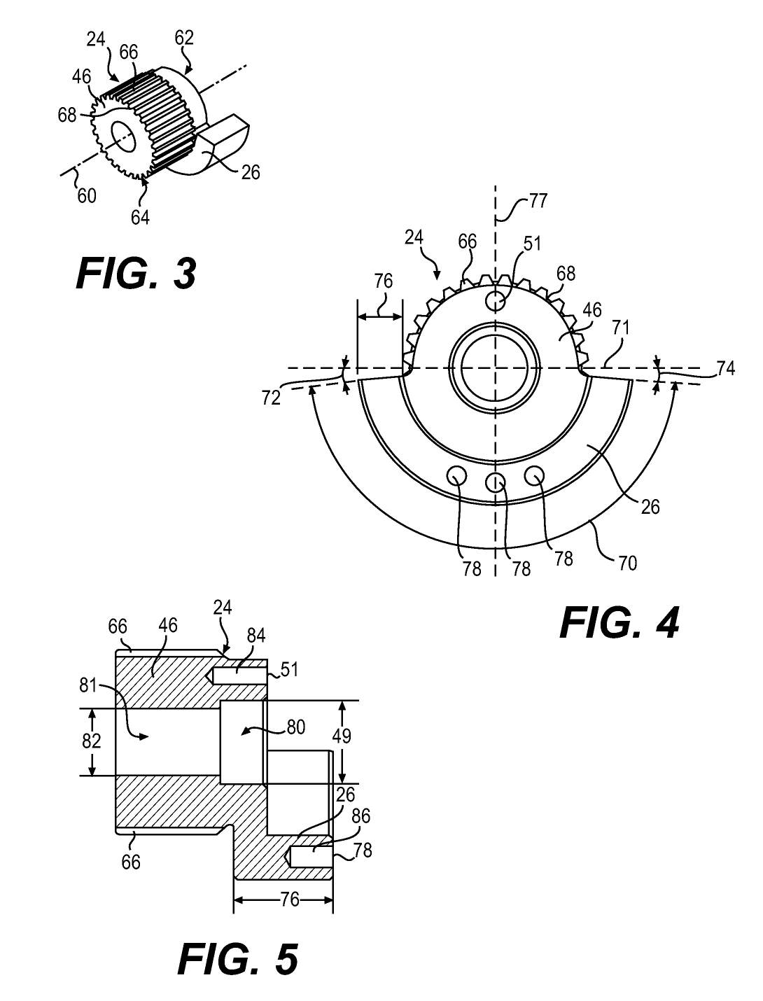

FIGS. 3-5 illustrate features of one embodiment of the male spline 24 and the counterweight 26 in more detail. As shown in FIG. 3, in this embodiment, the body 46 is substantially cylindrical. As used herein, the term “substantially cylindrical” as it refers to the body 46 includes instances in which the body 46 takes on the shape of a cylinder. However, the term “substantially cylindrical” also includes instances in which the shape of body 46 varies slightly with respect to a cylinder. For example, the body 46 shown in FIGS. 3-5 is substantially cylindrical although a plurality of teeth 66 and a plurality of grooves 68 are slight variations that vary the shape of the body 46 with respect to a cylinder.

Further, in the illustrated embodiment, the body 46 of the male spline 24 is disposed about a central axis 60 and includes a first end 62 and a second end 64. The plurality of teeth 66 are interspersed with the plurality of grooves 68 and disposed about the second end 64 of the body 46. The plurality of teeth 66 may be configured to mate with a plurality of female grooves on a corresponding part (e.g., a female spline in the crankshaft 14) in some embodiments. Further, in some embodiments, the plurality of teeth 66 may be formed from a pre-hardened material, such as an induction hardened material.

In the illustrated embodiment, the counterweight 26 is disposed about the first end 62 of the body 46 opposite the second end 64. The counterweight 26 is also disposed about a portion of the central axis 60 defined by an angle 70 shown in FIG. 4. For example, in the illustrated embodiment, axis 71 is perpendicular to central axis 60 and represents the location of a 180 degree angle about the central axis 60. The counterweight 26 is disposed about the angle 70, which in the illustrated embodiment is less than 180 degrees and defined by 180 degrees minus angles 72 and 74. In one embodiment, the angle 70 may be approximately 170 degrees such that each of angles 72 and 74 is approximately 5 degrees (e.g., 5 degrees plus or minus 1 degree). However, the angles shown are for illustrative purposes only, and in other embodiments, the angle 70 may be any suitable angle greater than, less than, or equal to 180 degrees.

Further, in some embodiments, the angle 70 may be selected at least in part based on a thickness 76 of the counterweight 26. For example, a ratio between the thickness 76 of the counterweight 26 and the angle 70 may be optimized (e.g., chosen to enable sufficient surface area to accommodate one or more balancing apertures 78). In some embodiments, the ratio may be approximately 0.16-0.24 millimeters for every 1 degree. For example, in one embodiment, the angle 70 may be approximately 170 degrees (e.g., 170 degrees plus or minus 2 degrees), and the thickness 76 may be approximately 33 millimeters (e.g., 33 millimeters plus or minus 1 millimeter). For further example, the thickness 76 may be between 32 millimeters and 34 millimeters. In this way, an embodiment of the counterweight 26 having a larger angle 70 may have a smaller thickness 76, as compared to an embodiment of the counterweight 26 having a smaller angle 70 and a larger thickness 76.

In certain embodiments, the angle 70 and/or the thickness 76 may be selected to enable placement of balancing apertures 78 about the circumference of the counterweight 26. The balancing apertures 78 may be configured to enable fine tuning of the counterbalance provided by the counterweight 26, for example, to accommodate for differences in the weight or size of the counterbalance 26 that arise during manufacturing. As such, the quantity and location of the balancing apertures 78 in a given embodiment is implementation-specific and may vary between different embodiments of the counterweight 26.

One or more features of the male spline 24 and/or the counterweight 26 may enable the counterweight 26 to counteract the imbalance inherent in the compressor 8 due to the operation of only the single piston 18. For example, the counterweight 26 may be located opposite the first alignment mechanism 51 with respect to axis 71. That is, the counterweight 26 may be centered about axis 77 (which is approximately perpendicular to axis 71 and runs through the center of the substantially cylindrical body 46 and the first alignment mechanism 51) such that angles 72 and 74 are approximately equal.

Further, this relative positioning of the counterweight 26 with respect to the first alignment mechanism 51 may enable proper positioning of the counterweight 26 with respect to the piston 18 when the first alignment mechanism 51 and the second alignment mechanism 52 are aligned. For instance, when the first and second alignment mechanisms 51 and 52 are aligned, the counterweight 26 is positioned on the side of the drive shaft 22 opposite from the piston 18. This relative positioning of the counterweight 26 and the piston 18 in the aligned position may enable the counterweight 26 to correct for the inherent imbalance present in the compressor 8 due to operation of only the single piston 18.

Further, the location of the balancing apertures 78 about the circumference of the counterweight 26 may be selected such that the weight of the counterweight 26 is approximately evenly distributed on either side of the axis 77. For example, if a single balancing aperture 78 is provided, the single balancing aperture 78 may be opposite alignment mechanism 51 with respect to axis 71 and along axis 77.

FIG. 5 illustrates a cross sectional side view of the male spline 24 and the counterweight 26 of FIGS. 3 and 4. This view illustrates internal features of the male spline 24 and the counterweight 26 in more detail. For example, as shown, the male spline 24 has the inner diameter 49 (which may be a first inner diameter of the male spline 24) defining a passageway 80 that is configured to receive the outer diameter 50 of the drive shaft 22. The male spline 24 also has an inner diameter 82 (which may be a second inner diameter of the male spline 24) defining a passageway 81 configured to receive the extension 44 of the fastener 40. In some embodiments, inner diameter 82 may be smaller than inner diameter 49 such that when the drive shaft 22 is received in the passageway 80, the drive shaft 22 does not extend into the passageway 81.

Further, in this embodiment, the first alignment mechanism 51 forms a blind hole 84 that is configured to receive the second alignment mechanism 52 formed in a corresponding shape (e.g., a pin). Similarly, the balancing aperture 78 is illustrated as forming a blind hole 86 extending into the counterweight 26. However, in other embodiments, the first alignment mechanism 51 and/or the balancing aperture 78 may take on a variety of other forms. For example, the balancing aperture 78 may be a through-hole that extends through the thickness 76 of the counterweight 26 in some embodiments.

Additionally, it should be noted that although in the illustrated embodiments, the male spline 24 and the counterweight 26 are configured to mate with or be integral with the drive shaft 22, the drive shaft 22 may take on a variety of other forms in other embodiments. That is, the male spline 24 and the counterweight 26 may mate with or be integral with any suitable type of shaft (e.g., engine drive shaft, freestanding shaft, etc.), including, but not limited to compressor drive shafts.

### INDUSTRIAL APPLICABILITY

The disclosed systems, including the male spline 24, the counterweight 26, and/or the drive shaft 22, may have a variety of industrial applications. For example, the disclosed systems may have industrial applicability in energy production systems, fuel pumping systems, and air compression systems. Further, the disclosed systems may be used in a variety of areas, including, but not limited to oil refineries, chemical plants, refrigeration plants, etc. In such applications and areas, the disclosed systems may enable compensation for imbalances present in rotational components, such as the drive shafts of single cylinder compressors, while providing compatibility with the drive format of spline-based devices, such as spline-based crankshafts of engines.

The operation of the power system 5 having the compressor 8 and the power source 10 that are coupled via the drive shaft 22 and the crankshaft 14 will now be explained. During operation of the power system 5, the power source 10 powers the operation of the compressor 8, which pressurizes an intake fluid. More specifically, the operation of the engine 12 will cause a rotation of the crankshaft 14. Rotation of the crankshaft 14 results in a corresponding rotation of the drive shaft 22, since the crankshaft 14 and the drive shaft 22 are mechanically coupled via the male spline 24. For example, grooves and teeth on the crankshaft 14 may mate with the plurality of grooves 68 and the plurality of teeth 66 of the male spline 24 to enable the rotation of the drive shaft 22 when the crankshaft 14 rotates.

Rotation of the drive shaft 22 powers the operation of the compressor 8 to enable compression of an intake fluid. Specifically, rotation of the drive shaft 22 drives the movement of the piston 18 of the compressor 8. The piston 18 acts on an intake fluid from the fluid intake port 16 by moving with respect to the intake fluid to increase the pressure of the intake fluid, thus producing compressed fluid.

Further, as the drive shaft 22 rotates, the male spline 24 and the counterweight 26 rotate. The rotation of the counterweight 26 provides an imbalanced force that counters the force imbalance that occurs during operation of the compressor 8. For example, the rotation of the counterweight 26 may be configured to generate a force that is equal in magnitude and opposite in direction (i.e., 180 degrees out of phase) to correct for the inherent imbalance in the compressor 8 due to the movement of only a single piston 18. As the drive shaft 22, the male spline 24, and the counterweight 26 rotate, the torque is transferred through the interference fit between the inner diameter 49 of the male spline 24 and the outer diameter 50 of the drive shaft 22.

Several advantages over the prior art may be associated with the disclosed systems. For example, the disclosed systems include the male spline 24, which enables the compressor 8 to be compatible with spline-based devices. This may be advantageous, for example, in instances in which the user desires to couple the compressor 8 to the power source 10 and the power source 10 is configured for a spline-based drive format. For example, the compressor 8 may be compatible with the engine 12 when the engine 12 is belt-driven as opposed to, for example, gear-driven.

Further, since the male spline 24, the counterweight 26, and the drive shaft 22 of the disclosed systems may be formed as partially or fully integrated assemblies, depending on the given embodiment, the disclosed systems may be tailored to a given implementation such that the desired components are provided in an advantageous configuration. For example, in implementations in which the compressor 8 includes an existing drive shaft 22, the male spline 24 and the counterweight 26 may be provided separate from the drive shaft 22 to enable the drive shaft 22 to be retrofitted with the male spline 24 and the counterweight 26.

Further, the disclosed systems enable additional customizations, for example, because the male spline 24 and the counterweight 26 may be formed as a single piece assembly. For further example, in implementations in which the compressor 8, or another shaft-driven or shaft-driving device, is provided without an integrated shaft, the disclosed systems may take the form of a single piece assembly including the male spline 24, the drive shaft 22, and the counterweight 26. The single-piece assembly may then be coupled to the existing compressor 8 or other device.

Another advantage provided by the disclosed systems is the ability to compensate for imbalances of the compressor 8 across the various embodiments of the compressor 8. For example, in some embodiments, the ratio between the thickness 76 of the counterweight 26 and the angle 70 may be approximately 0.16-0.24 millimeters for every 1 degree. By relating the thickness 76 of the counterweight 26 to the angle 70 in this manner, the disclosed systems may enable mitigation of the torsional dynamics from the compressor 8. Further, in some embodiments, the ability of the counterweight 26 to offset the imbalances in the compressor 8 may be fine tuned to a specific implementation. The fine tuning of the mitigation of the imbalances of the compressor 8 may be enabled, for example, by the balancing apertures 78. Specifically, in some embodiments, the counterweight 26 may be manufactured to include no balancing apertures 78, and the quantity and placement of the balancing apertures 78 may be selected by a user for the given implementation, for example, by considering the amount of imbalance needed to balance the given embodiment of the drive shaft 22. In this way, the counterweight 26 may enable large-scale imbalances to be corrected while also enabling small-scale imbalances to be corrected by fine tuning. The foregoing features may also enable differences between manufactured parts to be accommodated.

An additional advantage provided by the disclosed systems is that imbalances associated with the single piston 18 compressor 8 may be compensated for without the need for bulky counter-throws on the drive shaft 22 that increase the size of the overall system. Presently disclosed embodiments may compensate for the inherent imbalances in the single piston 18 compressor 8 by providing counterweight 26, thus enabling a smaller overall system.

It will be apparent to those skilled in the art that various modifications and variations can be made to the disclosed systems. Other embodiments will be apparent to those skilled in the art from consideration of the specification and practice of the disclosed systems. For example, although described as having male spline features, the disclosed spline/counterweight component may have female spline features, if desired. It is intended that the specification and examples be considered as exemplary only, with a true scope being indicated by the following claims and their equivalents.

What is claimed is:

1. A counterbalanced spline, comprising:
a substantially cylindrical body having a central axis and a plurality of teeth disposed about the central axis; and
a counterweight disposed about a portion of the central axis of the substantially cylindrical body.

2. The counterbalanced spline of claim 1, wherein the counterweight is configured to be disposed about a first end of the substantially cylindrical body, and the plurality of teeth are disposed about a second end of the substantially cylindrical body opposite the first end.

3. The counterbalanced spline of claim 1, wherein the substantially cylindrical body and the counterweight form a single-piece assembly.

4. The counterbalanced spline of claim 1, wherein the portion of the central axis about which the counterweight is disposed is defined by an angle; and a ratio between a thickness of the counterweight and the angle is approximately 0.16-0.24 millimeters for every 1 degree.

5. The counterbalanced spline of claim 1, wherein the substantially cylindrical body includes an alignment mechanism configured to axially align the substantially cylindrical body with a shaft configured to removably receive the substantially cylindrical body and the counterweight thereon.

6. The counterbalanced spline of claim 5, wherein the alignment mechanism includes an aperture configured to receive a pin disposed on the shaft.

7. The counterbalanced spline of claim 6, wherein the counterweight is disposed opposite the pin with respect to an axis extending through a center of the substantially cylindrical body.

8. The counterbalanced spline of claim 1, wherein the counterweight includes one or more balancing apertures disposed about a circumference of the counterweight.

9. The counterbalanced spline of claim 8, wherein the one or more balancing apertures form one or more blind holes extending into the counterweight.

10. The counterbalanced spline of claim 1, wherein the portion of the central axis about which the counterweight is disposed is defined by an angle, and the angle is between 168 degrees and 172 degrees.

11. The counterbalanced spline of claim 1, wherein the substantially cylindrical body includes a first inner diameter configured to removably receive a shaft.

12. The counterbalanced spline of claim 11, wherein the substantially cylindrical body includes a second inner diameter smaller than the first inner diameter and configured to removably receive a fastener.

13. A compression system, comprising:
a fluid compressor having a drive shaft;
a male spline configured to mate with an end of the drive shaft; and
a counterweight configured to be disposed about a portion of the male spline.

14. The compression system of claim 13, wherein the portion of the male spline about which the counterweight is disposed is defined by an angle; and a ratio between a thickness of the counterweight and the angle is approximately 0.16-0.24 millimeters for every 1 degree.

15. The compression system of claim 14, wherein the angle is between 168 degrees and 172 degrees.

16. The compression system of claim 14, wherein the thickness of the counterweight is between 32 millimeters and 34 millimeters.

17. The compression system of claim 13, wherein the male spline has an inner bore configured to form an interference fit with an outer diameter of the drive shaft.

18. The compression system of claim 13, wherein the counterweight and the male spline form a single-piece assembly; and the compression system further includes a bolt configured to pass through the male spline to removably connect the single-piece assembly to the drive shaft.

19. The compression system of claim 13, wherein the drive shaft includes a pin, and the male spline includes a blind hole configured to receive the pin to align the counterweight opposite a piston of the fluid compressor.

20. A power system, comprising:
an engine having a crankshaft with a female spline;
a fluid compressor having a drive shaft and a single piston reciprocatingly connected to the drive shaft;
a male spline configured to mate with the female spline and having an inner bore configured to removably receive an end of the drive shaft; and
a counterweight integral with the male spline and configured to be disposed about a portion of a central axis of the male spline defined by an angle, wherein a ratio between a thickness of the counterweight and the angle is approximately 0.16-0.24 millimeters for every 1 degree.
